(19) United States
(12) Patent Application Publication
(10) Pub. No.: US 2015/0134463 A1
(43) Pub. Date: May 14, 2015

(54) PERFORMANCE METRIC BASED BID PLACEMENT

(71) Applicant: Turn Inc., Redwood City, CA (US)

(72) Inventors: Ali Jalali, San Mateo, CA (US); Ali Dasdan, San Jose, CA (US); Kuang-chih Lee, Union City, CA (US)

(73) Assignee: Turn Inc., Redwood City, CA (US)

(21) Appl. No.: 14/075,392

(22) Filed: Nov. 8, 2013

(51) Int. Cl. G06Q 30/02

(52) U.S. Cl. CPC G06Q 30/0275
USPC 705/14.71

(57) ABSTRACT

Techniques and mechanisms described herein facilitate the performance metric based placement of bids. According to various embodiments, a first threshold value for bid placement may be identified. The first threshold value may designate a first threshold performance metric level for advertising opportunity bid requests received during a designated time period. An estimated performance metric may be determined for a designated advertising opportunity bid request received during the designated time period. A bid placement message may be transmitted via a communications interface when the estimated performance metric is greater than the first threshold value. The bid request may identify the designated advertising opportunity bid request and a bid placement value.

### TECHNICAL FIELD

The present disclosure relates generally to efficient resource utilization and more specifically to the efficient pacing of budgets for online advertising campaigns.

### DESCRIPTION OF RELATED ART

In online advertising, internet users are presented with advertisements as they browse the internet using a web browser. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible given one or more budget restrictions. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

Advertisers often prefer to spend their budget smoothly over the time in order to reach a wider range of audience accessible throughout a day and have a sustainable impact. However, the conversions may occur relatively rarely and the occurrence feedback may be delayed. Thus, a tradeoff exists between achieving budget and performance goals.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms for auction based bid adjustment. According to various embodiments, a first threshold value for bid placement may be identified. The first threshold value may designate a first threshold performance metric level for advertising opportunity bid requests received during a designated time period. An estimated performance metric may be determined for a designated advertising opportunity bid request received during the designated time period. A bid placement message may be transmitted via a communications interface when the estimated performance metric is greater than the first threshold value. The bid request may identify the designated advertising opportunity bid request and a bid placement value.

According to various embodiments, a second threshold value for bid placement may be identified. The second threshold value may designate a second threshold performance metric level for advertising opportunity bid requests received during the designated time period. The second threshold value may be determined at least in part based on the one or more historical performance metrics associated with previously received advertising opportunity bid requests. For instance, the second threshold value may be less than the first threshold value.

In some embodiments, transmitting the bid placement message via the communications interface when the estimated performance metric is greater than the first threshold value may involve determining a bid placement probability. The bid placement probability may identify a probability of selecting the designated advertising opportunity bid request for bid placement. For example, the bid placement probability may be equal to a target pacing rate that designates a desired proportion of purchased advertising opportunity bid requests to received advertising opportunity bid requests during the designated time period.

According to various embodiments, identifying the first and second threshold values may involve updating one or more threshold values associated with a past time period, the past time period preceding the designated time period. For instance, identifying the first and second threshold values may involve determining a mean threshold performance metric selected based on the one or more historical performance metrics. The mean threshold performance metric may be less than the first threshold value and greater than the second threshold value. Identifying the first and second threshold values may involve determining a threshold variance value. The threshold variance value may indicate a difference between the first and second threshold values.

In some implementations, a number of requests estimated to be received during the designated time period may be determined. For instance, the number of requests may be determined based on one or more of budget pacing information associated with the designated time period, a number of ad impressions targeted for purchase during the designated time period, and a number of bids targeted for placement during the designated time period.

According to various embodiments, the first threshold value may be determined based on the number of requests estimated to be received during the designated time period and a representation of a distribution of the historical performance metrics. The estimated performance metric may be an action rate or a click through rate.

### BRIEF DESCRIPTION OF THE DRAWINGS

The disclosure may best be understood by reference to the following description taken in conjunction with the accompanying drawings, which illustrate particular embodiments of the present invention.

FIGS. 1A-E illustrates graphs of budget pacing schemes, presented in accordance with one or more embodiments.

FIG. 2 illustrates an example of a budget pacing determination method, performed in accordance with one or more embodiments.

FIG. 3 illustrates an example of a target budget determination method, performed in accordance with one or more embodiments.

FIG. 4 illustrates an example of a server, configured in accordance with one or more embodiments.

FIG. 5 illustrates a bid decision determination method, performed in accordance with one or more embodiments.

FIG. 6 illustrates a request estimate determination method, performed in accordance with one or more embodiments.

FIG. 7 illustrates a request threshold value determination method, performed in accordance with one or more embodiments.

FIG. 8 illustrates a threshold window determination method, performed in accordance with one or more embodiments.

FIG. 9 illustrates a graph of a threshold value applied to a request distribution, presented in accordance with one or more embodiments.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular techniques and mechanisms related to advertising campaigns. However, it should be noted that the techniques and mechanisms of the present invention apply to a variety of different computing techniques and mechanisms. In the following description, numerous specific details are set forth in order to provide a thorough understanding of the present invention. Particular example embodiments of the present invention may be implemented without some or all of these specific details. In other instances, well known process operations have not been described in detail so as not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, techniques and mechanisms described herein facilitate performance metric based bid placement. Bids may be placed in the context of an efficient budget pacing scheme, which refers to the rate at which a budget is spent over time. When executing an online advertising campaign, an advertiser or an agent of an advertiser spends an advertising budget by bidding on advertising requests provided by a real time bidding (RTB) exchange. The advertiser may prefer that the budget be used to purchase high quality impressions. At the same time, the advertiser may prefer that the budget be spent relatively smoothly over a period of time. Techniques described herein may facilitate the determination of which advertising bid opportunity requests are suitable for bid placement. One or more performance metric threshold values may be determined. Bids may be placed on request opportunities with estimated performance metrics that are above a threshold value.

### Example Embodiments

In recent years, the amount of ad impressions sold through real time bidding (RTB) exchanges has experienced a tremendous growth. RTB exchanges provide a technology for advertisers to algorithmically place a bid on any individual impression through a public auction. This functionality allows advertisers to buy inventory in a cost effective manner and to serve ads to the right person in the right context at the right time. However, in order to realize such functionality, advertisers need to intelligently evaluate each impression in real time or near real time. Demand-side platforms (DSPs) provide real time bid optimization techniques to help advertisers determine a bid value for each ad request very quickly. For instance, a DSP may determine a bid value in milliseconds for close to a million bids per second.

In order to use the services of a DSP, an advertiser may specify one or more parameters for an advertising campaign. The advertising campaign may include features such as a target audience and one or more budget restrictions. A budget restriction may designate an amount of money that the DSP may and/or should spend on the purchase of advertising impressions during the execution of the advertising campaign. For instance, an advertising campaign may be associated with a daily budget, a weekly budget, or any other type of budget restriction.

In order to meet budget restrictions associated with an advertising campaign, a DSP may take a budget as input and calculate a serving schedule for the campaign. Based on the serving schedule, the ad serving system can attempt to spread out impressions served for a campaign to avoid spending the budget all at once. For instance, the system may attempt to spend a daily budget for a campaign uniformly over the course of a day. However, such a strategy ignores differences in internet traffic and advertising impression performance metrics. For instance, the traffic profile distribution and past performance metrics may be such that advertising impressions during one part of the day may be more valuable than advertising impressions during another part of the day.

According to various embodiments, techniques and mechanisms described herein facilitate smooth budget pacing that takes into account various types of performance and delivery information. A real time bid optimization procedure attempts to meet or maximize one or more campaign performance goals under one or more delivery constraints within the budget schedule.

According to various embodiments, a performance goal can be specified by designating a performance metric such as cost-per-click (CPC), cost-per-action (CPA), click-through-rate (CTR), or action-rate (AR). In general, a lower CPC or CPA is more desirable, while a higher CTR or AR is more desirable. A performance goal may include a target level for a metric or may indicate that the metric is to be maximized or minimized, whichever is appropriate.

According to various embodiments, a smooth budget delivery constraint may be used to prevent the campaign from finishing the budget prematurely or avoiding a bursty spending rate. For instance, a smooth budget delivery constraint may be expressed as not buying more than a set fraction of the impressions of interest before a set time. Such a constraint may help advertisers to have sustainable influence with their ads, to avoid pushing large amount of ads in peak traffic (while performance may be degraded), and/or to explore a broader range of audience.

Performance of real time bid optimization in a RTB environment can be challenging for any or all of various reasons. For example, click and conversion events can be very rare for non-search advertisement. Therefore, the variance when estimating past performance metrics can be large.

As another example, the decision as to whether to place a bid and how to evaluate the bid price may need to be performed for an individual ad request very quickly, for instance in only a few milliseconds. At the same time, some DSPs typically receive as many as a million ad requests per second while hundreds of millions of users simultaneously explore the web around the globe. The short latency and high throughput requirements can introduce extreme time sensitivity into the process.

As yet another example, much information can be missing when individual ad requests are evaluated in real time or near real time. For instance, the feedback on previous decisions may have a long delay in practice. The collection of click information can be delayed because of the duplication removal during the logging process. At the same time, many view-through actions can take up to seven days to be converted and attributed to the corresponding impressions.

According to various embodiments, techniques and mechanisms described herein provide an online approach to enhancing performance metrics for an advertising campaign while satisfying budget constraints such as a smooth delivery constraint and/or a budget limit for the campaign. A control feedback loop may be applied to iteratively estimate the future spending rate in order to impose smooth delivery constraints. The spending rate may be used to select high quality impressions and adjust the bid price based on the prior performance distribution to maximize the performance goal.

In some implementations, budget pacing information may be used to determine whether and how to bid on individual advertising opportunity bid requests. When an incoming ad request is received, whether the ad request will eventually cause a click or conversion event may be unknown at the time of bid optimization. Accordingly, the value of an incoming ad request may be estimated by the prediction of its CTR or AR, for instance using a statistical model.

In some embodiments, campaign-specific performance metric threshold values may be used on a per-period basis to ensure that the smooth delivery constraint is met. At the same time, the use of such threshold values may facilitate the exploration of opportunities on the boundary of high and low quality advertising requests.

According to various embodiments, advertising campaigns may be designated as flat CPM or dynamic CPM. In a dynamic CPM campaign, the bid price is determined dynamically for each bid submitted. In a flat CPM campaign, each bid submitted has the same bid price. For a flat CPM campaign, one goal may be to select a set of ad requests to bid on given budget pacing information such as a time period pacing rate.

According to various embodiments, when an ad request comes to the system, a performance metric such as click through rate (CTR) or action rate (AR) may be estimated. If the predicted performance metric value is larger than a threshold upper bound, the ad request may be kept and a bid price may be submitted to the RTB exchange from which the ad request originated. If instead the predicted performance metric value is below a threshold lower bound, the ad request may be dropped.

In some implementations, the upper and lower threshold bounds may be identical. Alternately, different upper and lower threshold bounds may be used. If the predicted value is in between the upper and lower bounds, the ad request may be selected for bidding according to a probabilistic decision making procedure. For instance, a decision may be made at random to bid on the ad request with a probability equal to the pacing rate determined for the time period.

In some implementations, techniques and mechanisms may be described herein as solving “optimization” problems or as “optimizing” one or more parameters. It should be noted that the term optimize does not imply that the solution determined or parameter selected is necessarily the best according to any particular metric. For instance, some optimization problems are computationally intense, and computing the best solution may be impractical. Accordingly, optimization may involve the selection of a suitable parameter value or a suitably accurate solution. In some instances, the suitability of a parameter value or solution may be strategically determined based on various factors such as one or more computing capabilities, problem characteristics, and/or time constraints.

According to various embodiments, techniques and mechanisms may be described herein as distributing a daily budget for an advertising campaign over the course of a day. However, it should be noted that different advertising campaigns may have different types of budgets and/or budget constraints. For instance, the budgets for some advertising campaigns may be allocated and smoothed over the course of an hour, a week, a year, or some other time period to meet the needs of an advertiser.

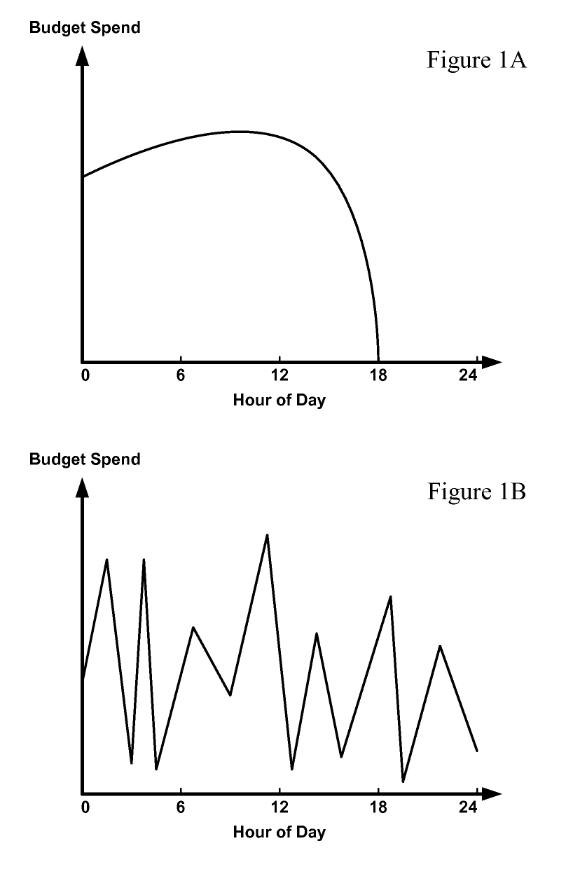

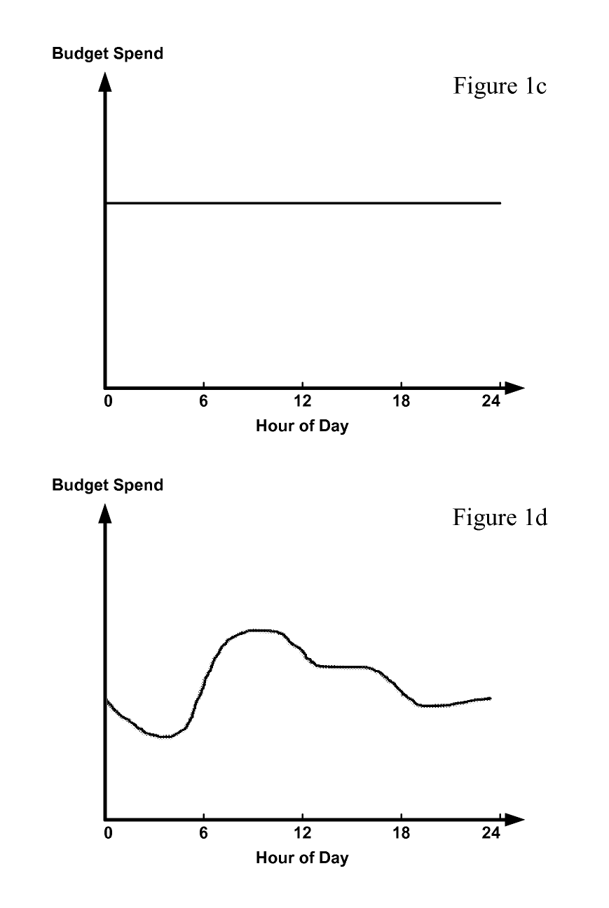

FIGS. 1A-E illustrates graphs of budget pacing schemes, presented in accordance with one or more embodiments. One example of a setting in which the budget pacing schemes illustrated in FIGS. 1A-E may occur is as follows. Suppose that a series of ad requests arrive sequentially. An advertiser would like to make a decision regarding whether to bid on each of the ad requests. The advertiser may specify a budget constraint such as a total daily budget to be spent on ad requests. In many advertising campaigns, advertisers would also like to impose a smooth budget delivery constraint to avoid situations such as a premature campaign stop or a fluctuating expenditure.

FIG. 1A illustrates an example of a premature campaign stop. In FIG. 1A, the entire daily budget of the advertising campaign is spent by hour 18. In this situation, the advertiser associated with the campaign has missed any opportunities that occur after hour 18 since no budget remains in the campaign for bidding on those advertising impressions. Accordingly, many advertisers would prefer to avoid a budget pacing scheme similar to that shown in FIG. 1A.

FIG. 1B illustrates an example of fluctuation in spend. Many advertisers prefer to avoid fluctuating spend for various reasons. For instance, many advertisers would like to be able to analyze their campaigns regularly, but high fluctuations in the budget may decrease the consistency of analysis results. Accordingly, many advertisers would prefer to avoid a budget pacing scheme similar to that shown in FIG. 1B.

FIG. 1C illustrates an example of an advertising campaign with uniform budget pacing. In this scheme the budget is uniformly split across the day. However, a uniform budget pacing scheme may impose one or more drawbacks. Accordingly, many advertisers would prefer to avoid a budget pacing scheme similar to that shown in FIG. 1C.

One potential drawback of a uniform budget pacing scheme is that, depending on the audience targeted by an advertising campaign, the volume of the online traffic can vary significantly throughout the day. For instance, it might be the case that traffic received during the first half of the day is more relevant than traffic received during the second half of the day. However, uniform budget pacing scheme ignores this difference in traffic relevance. In such a situation, some of the allotted budget may not be spent by the end of the day, or the budget may be spent on relatively low quality ad impressions in the second half of the day.

Another potential drawback of a uniform budget pacing scheme is that, the quality of the online traffic can change over the course of the day for different groups of an audience. Whether quality is being measured by CPC, CPA, CTR or AR, an advertiser may prefer that the budget be allocated primarily to time periods of the day with high quality. Due to these and other potential drawbacks associated with uniform budget pacing, a uniform budget pacing scheme may not meet the needs of at least some advertisers.

FIG. 1D illustrates an example of an advertising campaign with uniform budget pacing with respect to the traffic. In some instances, uniform budget pacing with respect to traffic may address some of the issues with uniform budget pacing with respect to time in terms of variation of traffic throughout the day. However, uniform budget pacing with respect to traffic may still ignore changes to the quality of the online traffic over the course of the day.

FIG. 1E illustrates an example of an advertising campaign with a budget pacing scheme that has a uniform baseline with additional budget portions allocated based on traffic quality. However, such a scheme may have large fluctuations that may violate smooth delivery constraints. As well, such a scheme may ignore changes in traffic volume over the course of the day.

In order to enforce the smooth delivery constraints, the overall daily budget B can be broken down into a sequence of time slot schedules {b₁, . . . , b_{T}}, where bₜ represents the budget that is allocated for advertising impressions available during time slot t. Since the entire budget is allocated for spending, the sum of the budgets allocated to the different time slots may be approximately or exactly equal to the overall budget for the day. According to various embodiments, various pacing strategies may be used to assign the bₜ values to select high quality impressions while adhering to one or more budget pacing conditions.

In some embodiments, each ad request i may fall within one of the time slot schedules. Each ad request xᵢ may be associated with a value vᵢ and a cost cᵢ. For instance, the value may be treated as representing the value for the advertiser if the given ad request is viewed by an audience member. The cost may be treated as representing the actual cost to the advertiser for the ad request, which is paid to the publisher who serves the corresponding impression.

In some implementations, the DSP may attempt to maximize the total value to the advertiser subject to the budget constraint. Accordingly, the DSP may attempt to solve the following maximization problem:

$$maximize {\sum }_{i = 1}^{n} {v}_{i} {x}_{i}$$

$$subject to {\sum }_{j ∈ {I}_{t}} {c}_{j} {x}_{j} \leq {b}_{t} ∀ t ∈ \{ 1 , … , T \}$$

In the preceding maximization problem, Iₜ represents the index set of all advertising requests that are received in the time slot t.

According to various embodiments, the maximization problem described in the immediately preceding paragraphs may be conceptualized as a theoretical or offline maximization problem since the cost and value of future ad requests may be unclear when decisions regarding budget pacing are made for a particular time period. That is, when an incoming ad request is received, a decision may need to be made regarding whether to bid on the ad request without observing data regarding future ad requests.

In particular embodiments, when bid values are determined dynamically, an estimated cost for the ad impression may need to be determined. In many RTB exchanges, the actual cost of an ad impression may be determined by an auction mechanism such as a second price auction. In such situations, a bid that is slightly higher than the estimated cost of the ad impression may need to be placed in order to win the second price auction and pay the estimated cost. The actual value of the bid placed for a given ad impression may be strategically determined based on one or more of various factors such as the characteristics of the auction employed by the RTB and the estimated cost of the ad impression.

Various approaches to solving optimization problems of the types described herein may suffer from one or more drawbacks. For example, some approaches to solving optimization problems model the budget constrained bidding optimization problem as an online knapsack problem (e.g., which is analogous to determining what packages are within a closed knapsack based on known weights of individual packages and filled knapsack). When employing such approaches, high quality ad requests may be selected based on an exponential function with respect to the budget period. As time goes by, increasingly higher quality ad requests can be selected. However, these types of approaches may rely on an underlying assumption of unlimited supply of future ad requests in the RTB environment. Such an assumption is impractical in many advertising campaigns, such as those campaigns with strict audience targeting constraints.

As another example, the problem of dynamic bidding price may be formulated using a multi-armed bandit framework (e.g., which is analogous to a gambler facing a set of slot machines or “one-armed bandits” and determining which slot machines to play, how many times to play each slot machine, and in which order to play the slot machines). Then, the strategy of upper confidence bound may be applied to explore the optimal price of online transactions. However, multi-armed bandit frameworks typically need to collect feedback quickly from the environment in order to update the utility function. The collection of bidding and performance information often involves a longer delay for display advertising in an RTB environment, thus rendering this approach impractical in many situations.

As yet another example, a general online linear programming algorithm may be used. A standard linear programming solver may be used to compute the optimal dual solution for the data which have been seen in the system. Then, the solution for the new instance can be decided by checking if the dual solution with the new instance satisfies the constraint. However, the true value and cost parameters for an incoming ad request may be unknown when the ad request arrives at the system. If these parameters are estimated, then the dual solution may need to be re-computed more frequently for each campaign in order to impose budget constraints accurately. This frequent re-computation may introduce high computational cost in the real time bidding system.

According to various embodiments, advertising campaigns may be divided into at least two categories. One category includes flat CPM campaigns, in which the same bid price is submitted whenever a decision is made to bid on an advertising request. Another category includes dynamic CPM campaigns, in which the bid price is dynamically determined. In both types of campaigns, a determination is made as to whether to bid on an advertising request.

In some embodiments, different metrics may be used to evaluate decisions made in different types of campaigns. For instance, the success of decisions made in a flat CPM campaign may often be based on a metric such as CTR or AR. In contrast, the success of decisions made in a dynamic CPM campaign may be based on a metric such as effective CPC (eCPC) or effective CPA (eCPA). The eCPC may be the cost-per-click that is actually realized, while the CPC may be the desired cost-per-click. Similarly, the eCPA may be the cost-per-action that is actually realized, while the CPA may be the desired cost-per-action.

According to various embodiments, the following optimization problem illustrates the type of calculation that may be performed in order to determine whether to bid on an ad request and, if in a dynamic CPM campaign, what bid to place on the ad request.

$$minimize - C T R , - A R , eC P C , or eC P A$$

$$such that \vert {\sum }_{t}^{T} s ( t ) - B \vert \leq ε$$

$$\vert s ( t ) - {b}_{t} \vert \leq {δ}_{t} ∀ t ∈ \{ 1 , … , T \}$$

$$eC P M \leq M$$

According to various embodiments, the first constraint in the preceding optimization problem may be treated as the total daily budget constraint, where s(t) represents the budget spent during time slot t, and ε represents an upper bound on the underspend or overspend total. The second constraint may be treated as enforcing smooth budget delivery according to the schedule bₜ, where δₜ represents an upper bound on the underspend or overspend for time slot t. The third constraint may be treated as requiring that eCPM does not exceed the cap M. This constraint may help make a dynamic CPM campaign to appear more like a CPM campaign on average over time.

According to various embodiments, the preceding optimization problem may be used to select the parameter bₜ. For instance, the total budget B and the average impression cost cap M may be set for a campaign by the advertiser.

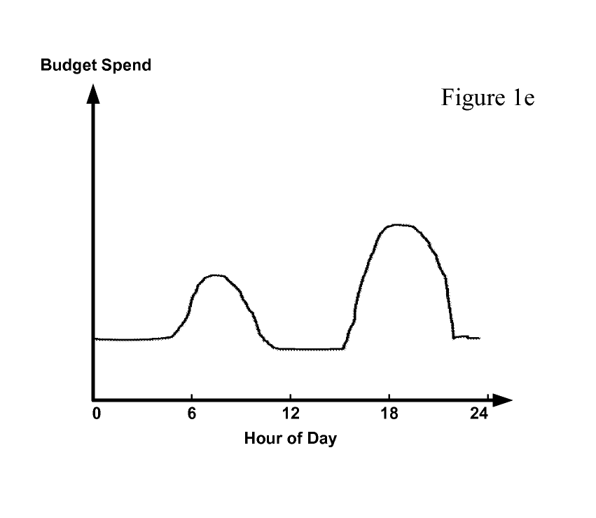

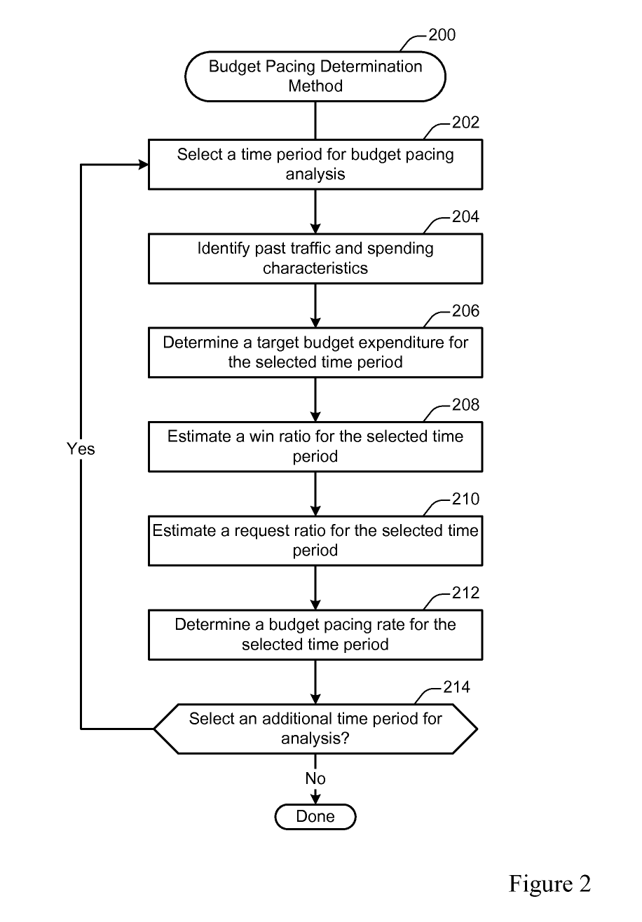

FIG. 2 illustrates an example of a budget pacing determination method 200, performed in accordance with one or more embodiments. The method 200 may be used to calculate a delivery schedule in real-time or near real-time for an advertising campaign. For example, the delivery schedule may be used to spread out the actions of acquiring impressions for a campaign throughout the day. For instance, a day can be broken down into T time periods. In each time period, a target budget can be assigned for spending in association with the each campaign.

Since advertising requests may be purchased via an auction mechanism, the actual budget spent for a time period may differ somewhat from the target budget for the time period. For instance, the actual amount spent during a time period may be determined by factors such as the bid amount for the time period, the win rate for the time period, and the number of requests bid upon during the time period.

In some embodiments, the delivery schedule may designate a per-period pacing rate for a time period in order to spend approximately the target budget for the time period. The pacing rate may designate the portion of incoming ad requests that are bid on for the campaign during the time period. For instance, the pacing rate may indicate that 15% of the incoming ad requests during the time period are to be bid on for the advertising campaign.

At 202, a time period for budget pacing analysis is selected. According to various embodiments, decisions regarding budget pacing may be made in real-time or near real-time. Accordingly, the time period selected for analysis may be the next time period in which advertising requests are received. Initially, the first time period may be selected.

According to various embodiments, a day may be divided into various numbers of time periods. For instance, a day may be divided into time periods of ten seconds, one minute, five minutes, or any suitable length of time. In some campaigns, all time periods for a campaign may be assigned to have equal length. Alternately, in some campaigns, different time periods may have different lengths.

In some embodiments, the amount of money spent during a given time period is considered to be proportional to the number of impressions served at that time period. This amount of money spent during a time period may be referred to as the “spend” of acquiring inventory for the time period. In general, the price of individual impressions for a particular campaign may remain approximately constant during a given time period. For instance, the length of the time period may be chosen such that the variance of individual impression price for each campaign is small.

At 204, past traffic and spending characteristics are identified. According to various embodiments, various types of information associated with previous time periods may be used to facilitate the determination of a pacing rate for the time period being analyzed. The past traffic and spending characteristics may include, but are not limited to, the actual spend for one or more previous periods, the pacing rate for one or more previous periods, the win rate for one or more previous periods, the number of requests for one or more previous periods, and various historical data.

In some embodiments, past traffic and spending characteristics may be stored in a storage system for the purpose of traffic analysis. For instance, when a time period is completed, information regarding the advertising requests received, the bids placed, the budget spent, and other such characteristics may be stored. Some or all of this information may then be retrieved for analysis during subsequent time periods.

In some embodiments, the actual spend for a previous time period may indicate that actual amount of budget that was spent on advertising requests for the previous time period. The actual amount spent may depend on factors such as the bid amount for the previous time period, the number of bids bid upon during the previous time period, and the percentage of successful bids during the previous time period.

In some embodiments, the win rate for a previous time period may identify the percentage or proportion of bids placed during the previous time period that were successful. For instance, if bids were placed on 5,000 adverting requests during the previous time period and the advertising campaign was successful in purchasing 1,000 of those requests, then the win rate for the previous time period would be 20%.

In some embodiments, the number of requests for a previous time period may identify the number of advertising requests for the previous time period on which it would have been possible to place a bid. In some instances, the number of requests may be defined as the number of available advertising requests that fall within one or more constraints or conditions specified by the advertising campaign. For instance, the advertising campaign may target one or more specific audiences or exclude one or more specific audiences.

In some embodiments, historical data from one or more previous time periods may be identified. Historical data may be used to make predictions regarding the time period selected for analysis. For example, historical data may indicate information such as a number of requests received during a previous time periods in the same day and/or a number of requests received during a previous time period in a previous day. As another example, historical data may indicate information such as a win rate during a previous time periods in the same day and/or a win rate during a previous time period in a previous day.

At 206, a target budget expenditure is determined for the selected time period. According to various embodiments, various techniques may be used to determine the target budget spend. For example, in a uniform budget pacing approach, the budget may be spent approximately evenly over the course of a day. As another example, relatively higher budget amounts may be allocated to time slots where a campaign has a greater chance to spend the budget on higher quality ad impressions. A higher quality ad impression may be one that has an increased probability of triggering an event of interest such as a click or conversion.

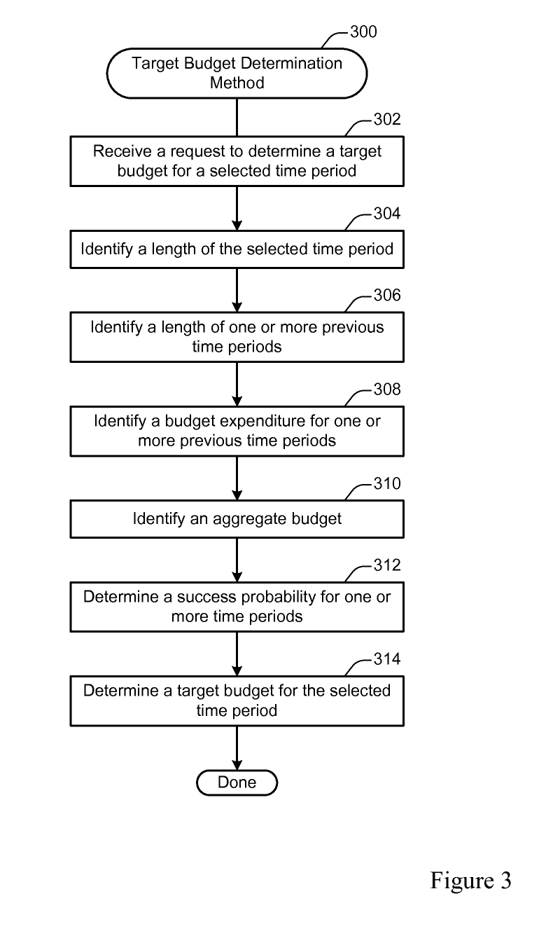

According to various embodiments, any of various types of budget distributions may be applied to an advertising campaign by selecting an appropriate target budget for each time period. For example, an approximately uniform pacing strategy may be implemented by adjusting the ideal budget expenditure to be approximately even over the course of the day. As another example, the target budget may be selected to weight certain periods of the day more highly. FIG. 3 describes examples of methods that may be used to determine a target budget for a time period according to different budget pacing strategies.

At 208, a win ratio for the selected time period is estimated. According to various embodiments, the estimated win ratio for the selected time period may identify an estimated ratio of win rates for different time periods. For instance, the estimated win ratio for the selected time period may identify an estimated ratio of the win rate for the immediately preceding time period and the estimated win rate for the selected time period.

In some embodiments, the win ratio for the selected time period may be estimated by combining information describing actual win ratios. For instance, the actual win ratio for the selected time period and the immediately preceding time period may be combined with historical information such as actual win ratios for time periods during previous, hours, days, or weeks.

At 210, a request ratio for the selected time period is estimated. According to various embodiments, the estimated request ratio for the selected time period may identify an estimated ratio of numbers of requests received during different time periods. For instance, the estimated request ratio for the selected time period may identify an estimated ratio of the number of requests received during the immediately preceding time period and the estimated number of requests to be received during the selected time period.

In some embodiments, the request ratio for the selected time period may be estimated by combining information describing actual numbers of requests. For instance, the actual number of requests for the selected time period and the immediately preceding time period may be combined with historical information such as actual numbers of requests for time periods during previous, hours, days, or weeks.

At 212, a budget pacing rate is determined for the selected time period. According to various embodiments, the budget pacing rate may identify the proportion of incoming ad requests received during the selected time period on which to bid. The budget pacing rate may be determined based on any of various factors which may include, but are not limited to: the estimated win ratio for the selected time period, the estimated request ratio for the selected time period, the target budget expenditure for the selected time period, and the budget expenditure for the immediately preceding time period.

In some embodiments, the budget pacing rate may be determined by calculating the result of a formula such as the following formula:

$$pacing\_rate ( t ) = \frac{target\_budget ( t )}{budget\_spent ( t - 1 )} * request\_ratio ( t ) * win\_ratio ( t )$$

In some embodiments, the formula may be written as follows:

$$pacing\_rate ( t ) = \frac{target\_budget ( t )}{budget\_spent ( t - 1 )} * \frac{requests ( t - 1 )}{requests ( t )} * \frac{win\_rate ( t - 1 )}{win\_rate ( t )}$$

In some embodiments, determining the budget pacing rate may involve storing the budget pacing rate on a storage system or in memory. The budget pacing rate may then be used to identify incoming ad requests on which to bid. For instance, if the budget pacing rate is 10%, then 10% of the incoming ad requests received during the selected time period that meet the criteria of the advertising campaign may be bid upon.

In particular embodiments, a pacing rate may be saved to local storage, for instance in a control server, when the pacing rate is updated. If the service is restarted, the pacing module may attempt to re-load all previous pacing information to avoid resetting the pacing rate to the initial values.

In particular embodiments, a pacing rate may be decreased below the rate that would otherwise be used as the day or other longer time interval draws to a close in order to prevent overspending. In some instances, a module may periodically determine whether the current aggregate spend is less than the daily cap and the cap for the selected time interval.

In particular embodiments, different pacing strategies may be executed for different types of advertising requests. Alternately, or additionally, pacing strategies may be changed by altering the techniques used to compute the pacing rate. For instance, one formula used to compute a pacing rate may be substituted for a different pacing rate formula.

At 214, a determination is made as to whether to select an additional time period for analysis. As discussed with respect to operation 202, decisions regarding budget pacing may be made in real-time or near real-time. Accordingly, the time period selected for analysis may be the next time period in which advertising requests are received. When a time period has passed, the next time period may be selected. For instance, time periods may continue to be selected until the advertising campaign or the day is completed.

FIG. 3 illustrates an example of a target budget determination method 300, performed in accordance with one or more embodiments. According to various embodiments, the method 300 may be performed in succession for a number of time periods in order to distribute a budget approximately uniformly over the time periods. For instance, the method 300 may be performed for each time period within a day in order to distribute the budget for the day uniformly over the day.

At 302, a request to determine a target budget for a selected time period is received. According to various embodiments, the request may be received as part of a procedure for determining a pacing rate for the selected time period, as discussed with respect to FIG. 2. For instance, the request may be generated in conjunction with the operation 206 described with respect to FIG. 2.

At 304, a length of the selected time period is identified. According to various embodiments, the length of the selected time period may indicate the amount of time during which operations associated with the selected time period take place. For instance, the target budget may be determined for use during the selected time period. The target budget for the time period may then be applied to ad requests received during the selected time period.

According to various embodiments, the length of time and other parameters may be determined by retrieving them from memory or a storage system. For instance, the system may store information such as the length of time of each time period, the budget expenditure for past time periods, and other parameters. This information may then be retrieved upon request for use in analysis or for other purposes.

At 306, a length of one or more previous time periods is identified. For instance, the length of each time period during the course of the day may be identified. The lengths of previous time periods may be identified individually or in the aggregate. For example, a running total of the length of time associated with all previous time periods during the course of the day may be maintained and updated.

In some implementations, each time period may be assigned the same length. Alternately, different time periods may be assigned different lengths. For instance, some periods of the day may be associated with high volatility in terms of the quantity and quality of advertising requests received and thus may be assigned shorter time periods. Other periods of the day may be associated with low volatility and be assigned longer time periods.

At 308, a budget expenditure for one or more previous time periods is identified. For instance, the budget expenditure of each time period during the course of the day may be identified. The budget expenditures of previous time periods may be identified individually or in the aggregate. For example, a running total of the budget expenditure associated with all previous time periods during the course of the day may be maintained and updated.

At 310, an aggregate budget is identified. According to various embodiments, the aggregate budget may identify a budget amount that is allocated for expenditure over a longer interval of time. The aggregate budget may be identified in order to divide the aggregate budget into allocations for the longer time interval among the different time periods in such a way that the budget constraint for the longer time interval is satisfied. For instance, the aggregate time interval may indicate an amount of money allocated for expenditure over a day, a week, an hour, or some other interval of time.

In some implementations, the aggregate budget may identify a target budget expenditure for the longer time interval. Alternately, or additionally, the aggregate budget may identify a maximum budget for the longer time interval.

At 312, a success probability for one or more time periods is determined. In some implementations, the success probability may be used to incorporate historical information into budget pacing analysis. For instance, an advertising campaign and/or pacing procedure designer may incorporate domain-specific knowledge into budget pacing.

For example, a designer with knowledge or experience in car dealing might believe that advertising during particular hours of the day or days of the week is more successful than advertising during other time periods. Based on this knowledge, the designer may define success probabilities to bias the budget pacing toward these desirable time periods.

As another example, a business owner may choose to restrict advertisement to a time period encompassing the hours of operation of the business. For instance, most advertising may be performed when the business is open, with a gradual increase in advertisement during the time period before the business opens. Suppose, for instance, that the business is a restaurant. The restaurant may prefer to begin presenting advertisements in the hours leading up to lunch time. Then, advertisement may be decreased during the early afternoon and increased again closer to the dinner time.

In some implementations, a success probability for a time period may indicate the probability of a click, conversion, or other successful outcome for the time period. Alternately, a success probability may be associated or correlated with the probability of a successful outcome. A success probability may be calculated exactly or estimated. For instance, a success probability may be determined by analyzing campaign history data or measuring the performance of the campaign during previous time periods.

According to various embodiments, potentially many different success probabilities may be determined. For instance, success probabilities may be combined to produce a discrete probability density function that assigns a success probability for each period during the course of a longer time interval such as a day. When a discrete probability density function is used, the success probabilities over the course of the day may sum to one. In such a model, higher probabilities may be associated with higher success rates but may not indicate the actual estimated success rate for a given time period. In this way, a probability density function may be used to weight the budget allocation among the different time periods based on the relative quality of the ad impressions received in different time periods.

In some implementations, one or more actual success metrics may be calculated exactly, as opposed to success probabilities, based on received success metric information for a given time period. Alternately, or additionally, one or more success probabilities may be estimated for the selected time period and even for periods in the past since information regarding the success of recent advertisements may be unavailable for a period of time.

At 314, a target budget for the selected time period is determined. According to various embodiments, the target budget for the selected time period may be determined by any of various budget pacing strategies. For example, a uniform budget pacing strategy may be applied. As another example, a budget pacing strategy may allocate a larger budget to time periods in which advertising requests have a higher probability of success. For instance, some periods of time may be associated with a higher probability of clicks or conversions for advertising requests.

In some implementations, the target budget may be determined based on a uniform pacing strategy. A uniform pacing strategy may attempt to spend the aggregate budget evenly over the course of the day, even as the number and quality of advertising requests changes. For instance, the target budget bₜ for period t may be calculated based on the following formula. In this formula, B represents the aggregate budget, spend(m) represents the budget expenditure during the time period m, L(t) represents the length of the selected time period t, and L(m) represents the length of the previous time period m.

$${b}_{t} = ( B - {\sum }_{m = 1}^{t - 1} spend ( m ) ) \frac{L ( t )}{{\sum }_{m = t}^{T} L ( m )}$$

In some implementations, each time period during a longer interval such as a day may be assigned an equal length. When such a strategy is implemented, the previous equation may be simplified to the following formula. In the following formula, T represents the total amount of time that is divided into time intervals. For instance, T may represent the amount of time that passes during one day.

$${b}_{t} = ( B - {\sum }_{m = 1}^{t - 1} spend ( m ) ) \frac{1}{T - t}$$

In some implementations, a budget pacing strategy may allocate a larger portion of the budget to time periods in which advertising requests have a higher probability of success. For instance, the target budget bₜ for period t may be calculated based on the following formula. In this formula, pₜ represents the probability of success during period t. As described herein, the probability of success may be defined in various ways based on the strategic objectives of the advertising campaign.

$${b}_{t} = ( B - {\sum }_{m = 1}^{t - 1} spend ( m ) ) \frac{{p}_{t} \cdot L ( t )}{{\sum }_{m = t}^{T} {p}_{m} L ( m )}$$

In some implementations, each time period during a longer interval such as a day may be assigned an equal length. When such a strategy is implemented, the previous equation may be simplified to the following formula. In the following formula, T represents the total amount of time that is divided into time intervals. For instance, T may represent the amount of time that passes during one day.

$${b}_{t} = ( B - {\sum }_{m = 1}^{t - 1} spend ( m ) ) \frac{{p}_{t}}{{\sum }_{m = t}^{T} {p}_{m}}$$

In some implementations, initialization values may be used when calculating formulas described herein, for instance for the first period of the day. For example, initialization values may be set based on the results of time intervals in previous days. As another example, initialization values may be set to designated constant values such as zero values, small non-zero values, or other constant values.

In some implementations, one or more of the operations shown in FIG. 3 may be omitted. Alternately, or additionally, one or more additional operations not shown in FIG. 3 may be performed. For example, when implementing a uniform budget pacing strategy, determining a success probability may be omitted. As another example, other budget pacing strategies may involve information not discussed with respect to FIG. 3. In particular embodiments, the specific information used to determine the target budget may be strategically determined based on the type of budget pacing being performed.

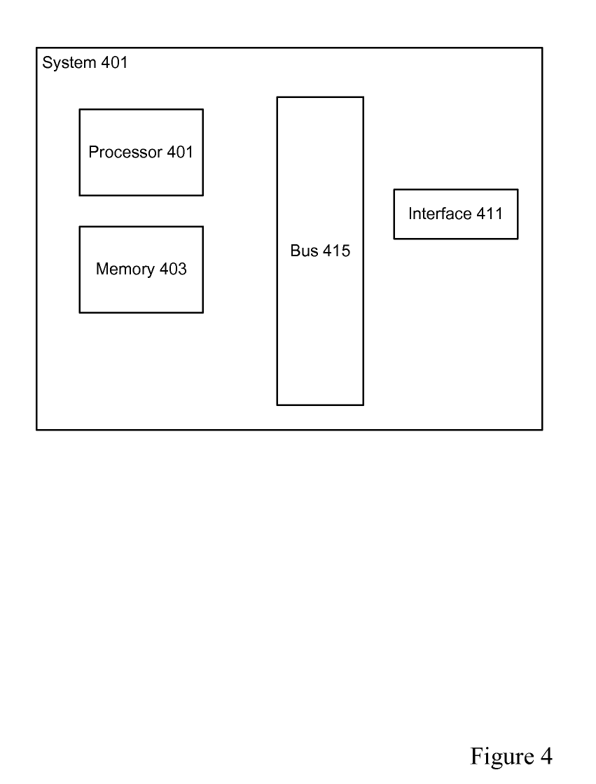

FIG. 4 illustrates one example of a server. According to particular embodiments, a system 400 suitable for implementing particular embodiments of the present invention includes a processor 401, a memory 403, an interface 411, and a bus 415 (e.g., a PCI bus or other interconnection fabric) and operates as a counter node, aggregator node, calling service, zookeeper, or any other device or service described herein. Various specially configured devices can also be used in place of a processor 401 or in addition to processor 401. The interface 411 is typically configured to send and receive data packets over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. Although a particular server is described, it should be recognized that a variety of alternative configurations are possible.

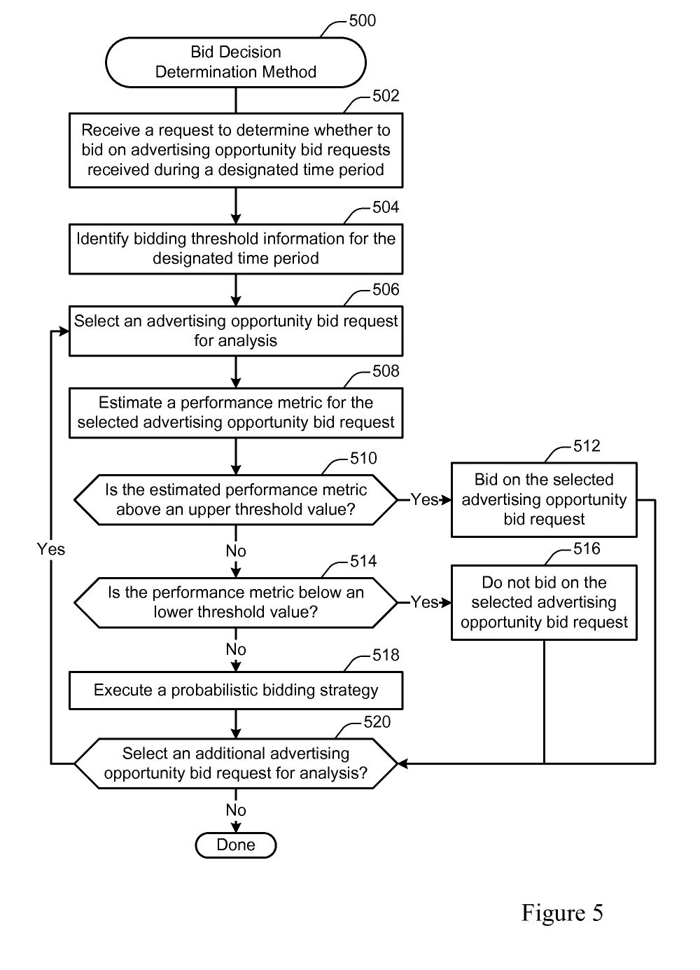

FIG. 5 illustrates a bid decision determination method 500, performed in accordance with one or more embodiments. According to various embodiments, the method 500 may be used to determine whether to bid on one or more advertising opportunity bid requests. In some implementations, an advertising campaign execution system may receive one or more advertising opportunities during a time period. The advertising campaign execution system may place bids on none, some, or all of these bid requests depending on a variety of factors such as the number and quality of the bid requests received during the time period and the campaign-specific budget pacing information determined for the time period.

At 502, a request is received to determine whether to bid on advertising opportunity bid requests received during a designated time period. In some embodiments, the request may be generated as part of a partially or fully automated system configured to manage advertising bid placement and advertising budget expenditure for one or more advertising campaigns. For instance, a request may be automatically generated for each or selected ones of the bid requests received during the time period.

According to various embodiments, the designated time period may be of any of various lengths of time. For instance, the designated time period may be on the order of seconds, minutes, or hours. In some instances, different time periods may have different lengths. Alternately, different time periods may each be of the same length of time.

At 504, bidding threshold information for the designated time period is determined. According to various embodiments, various types of campaign-specific budget pacing information may be determined for a time period, as discussed with respect to FIGS. 1-4. This budget pacing information may be used to provide smooth budget pacing of a budget for an advertising campaign over the course of a longer time interval such as a day or week.

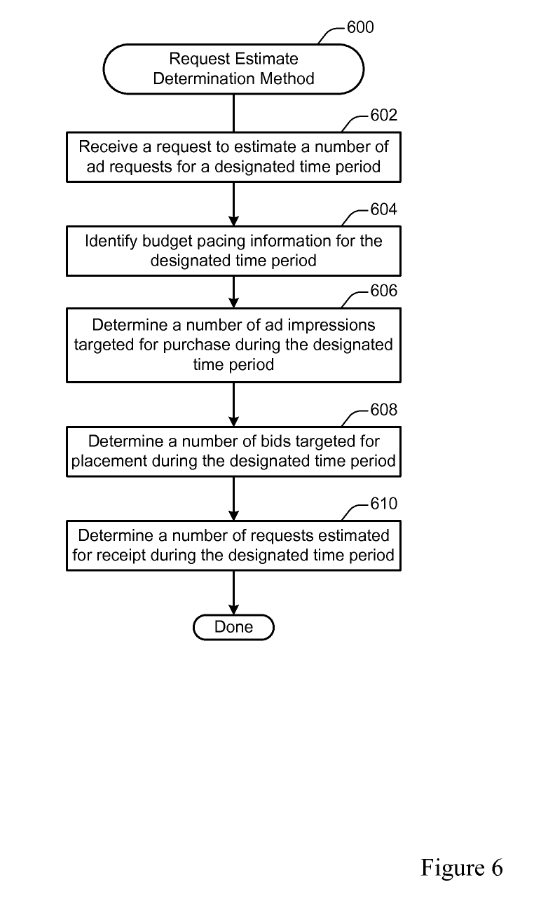

In some implementations, campaign-specific budget pacing information may be used to determine bidding threshold information for a designated time period. Techniques for determining bidding threshold information are discussed in greater detail with respect to FIGS. 6-9. Bidding threshold information may identify one or more performance metric thresholds for use in determining whether to bid on an advertising bid request opportunity.

At 506, an advertising opportunity bid request is selected for analysis. According to various embodiments, one or more advertising opportunity bid requests may be received during the designated time period. For instance, advertising opportunity bid requests may be received at the advertising campaign execution system from a source such as an RTB exchange via a communications interface. Advertising opportunity bid requests may be processed in any order. For instance, requests may be processed sequentially or near sequentially in order of receipt. Also, requests may be processed in serial or in parallel.

At 508, a performance metric is estimated for the selected advertising opportunity bid request. For instance, the estimated performance metric may be measured as a click through rate (CTR) or an action rate (AR).

Various techniques may be used to estimate CTR or AR. For example, since conversions are rare events, a hierarchical structure of features for each triplet combination of (user, publisher, advertiser) may be used to smooth and impute the AR for advertisements that have a relatively low number of conversion events. As another example, users may be clustered based on their behaviors and interests. Then CTR or AR may be estimated in each user cluster. As yet another example, a machine learning method (e.g., logistic regression) and a collaborative filtering technique may be used to combine multiple CTR or AR estimates from different levels in a hierarchy or different user clusters to produce a an estimate.

For instance, if the triplet approach is used, then each advertisement may be treated as a leave in an advertiser tree hierarchy. The hierarchy may start with a root and continue layer by layer by classification such as advertiser category, advertiser, insertion order, package, line item, ad and advertisement. Using the historical data, an AR or CTR may be assigned to each node in the tree by aggregating total number of impressions and actions of their children as a raw estimate. Similar hierarchy and raw estimations may be determined for other dimensions, such as those corresponding to publishers and users.

According to various embodiments, after constructing all three hierarchies with initial raw estimates, a smoothing algorithm may be used to adjust the raw estimates on different levels based on factors such as the similarity and closeness of (user, publisher, advertiser) triplet on the hierarchy trees. Then, for each triplet on the leaves of the trees, a logistic regression over the path from that leaf to the root may be computed to determine the estimated performance metric for the hierarchy tree leaf node triplet.

At 510, a determination is made as to whether the performance metric is above an upper threshold value. For instance, the system may determine whether the bid request has a CTR or AR above an upper threshold value identified at operation 508. A bid with an estimated performance metric above the upper threshold value may be one that is of sufficiently high quality that a bid should be placed.

At 512, a bid is placed on the selected advertising opportunity bid request if the performance metric is above an upper threshold value. According to various embodiments, placing a bid may involve transmitting a message identifying the bid. For instance, the message may be transmitted to a bid exchange from which the bid request originated. The message may identify the request on which the bid is placed and the value of the bid being placed.

According to various embodiments, the bid value may be fixed. For instance, an advertising campaign may be associated with a fixed bid value that is identified by the advertiser, by the advertising campaign execution system, or by different parties working together. In some implementations, using a fixed bid value may allow a response to an incoming bid opportunity request to be determined faster than would be the case if a dynamic bid value is computed. A fixed bid value may be determined based on information such as historical performance metrics, historical bid values, and historical advertising opportunity request data.

According to various embodiments, the bid value may be dynamically determined. For example, the bid value may be determined at least in part based on historical information such as historical performance metrics, historical bid values, and historical advertising opportunity request data. As another example, the bid value may be determined at least in part based on dynamic information such as a number of requests received during a time interval, a win rate for a time interval, an actual budget expenditure for a time interval, and a target budget for a time interval.

At 514, a determination is made as to whether the performance metric is below a lower threshold value. For instance, the system may determine whether the bid request has a CTR or AR below a lower threshold value identified at operation 508. A bid with an estimated performance metric below the lower threshold value may be one that is of sufficiently low quality that a bid should not be placed.

At 516, a bid is not placed on the selected advertising opportunity bid request if the performance metric is above an upper threshold value. According to various embodiments, not placing a bid may involve taking no further action related to the bid. Alternately, a message declining the bid may be transmitted. For instance, the message may be transmitted to a bid exchange from which the bid request originated. The message may identify the bid request that has been declined.

At 518, a probabilistic bidding strategy is executed. According to various embodiments, executing a probabilistic bidding strategy may involve placing a bid on the selected ad request with a designated probability. For instance, a bid may be placed with a probability equal or approximately equal to the pacing rate. By including a probabilistic bidding strategy for at least a portion of the performance metric range, the actual budget expenditure for the designated time period may be made to more closely match the target budget expenditure for the designated time period.

At 520, a determination is made as to whether to select an additional advertising opportunity bid request for analysis. According to various embodiments, requests may continue to be selected until the time period is over, until a designated number of advertising bid requests are successful, until a designated number of bids have been placed, or until some other criterion is met.

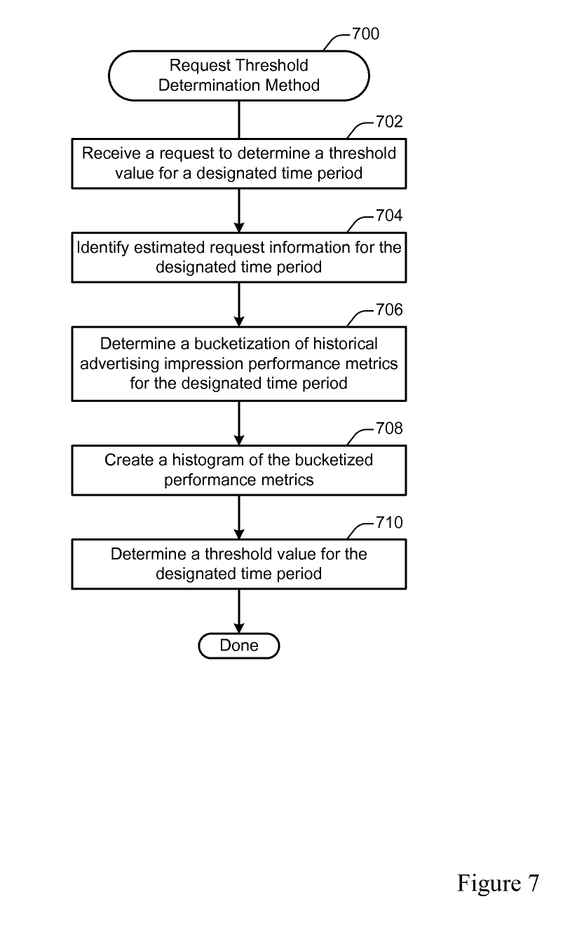

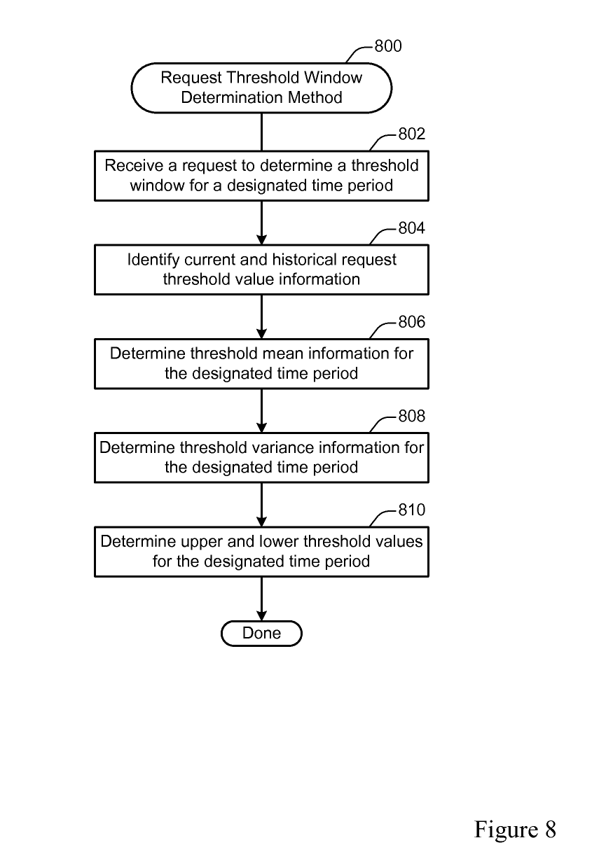

According to various embodiments, a time period may be associated with one, two, or any number of bidding thresholds for an advertising campaign. For example, in some implementations the upper and lower threshold values discussed with respect to FIG. 5 may be identical. As another example, more than two threshold value levels may be used. Different threshold levels may be associated with different decisions regarding whether or not to bid and/or different bidding values. FIGS. 7 and 8 describe examples of various techniques that may be used to determine bidding thresholds.

According to various embodiments, different bidding strategies may be employed based on the number of threshold values used. For example, bids may be automatically placed or not placed for different performance metric ranges. As another example, different bid ranges may be associated with different probabilities of bid placement. For instance, an upper performance metric range may be associated with a relatively high probability of bid placement, while a lower performance metric range may be associated with a relatively low probability of bid placement.

FIG. 6 illustrates a request estimate determination method 600, performed in accordance with one or more embodiments. According to various embodiments, the method 600 may be used to estimate a number of advertising requests received during a designated time period. The number of requests may be used to determine one or more threshold values for determining whether to bid on advertising request opportunities received during the designated time period.

At 602, a request is received to estimate a number of ad requests received during a designated time period. According to various embodiments, the request may be generated as described with respect to operation 504 in FIG. 5. For instance, the request may be generated once for each time period analyzed.

At 604, budget pacing information is identified for the designated time period t. According to various embodiments, the budget pacing information may include various types of data described with respect to FIGS. 1-4. For instance, the budget pacing information may include a budget amount allocated for the time period (e.g., s(t)), a fixed bid amount (e.g., c*) associated with the advertising campaign, an estimated win rate (e.g., win_rate(t)) for the designated time period, and a pacing rate (e.g., pacing_rate(t)) determined for the designated time period. The budget pacing information may be retrieved from memory or a storage system configured to store information used in advertising campaign analysis.

At 606, a number of ad impressions targeted for purchase during the designated time period is determined According to various embodiments, the number of ad impressions targeted for purchase may be determined by factors such as the budget amount allocated for the designated time period (e.g., s(t)) and the bid amount (e.g., c*) designated for bidding on advertising requests associated with the advertising campaign.

In some implementations, the total number of ad impressions targeted for purchase during the designated time period may be determined by the following equation in order to meet the allocated budget s(t) using a fixed bid value c*.

$${imps}^{*} ( t ) = \frac{s ( t )}{{c}^{*}}$$

At 608, a number of bids targeted for placement during the designated time period is determined According to various embodiments, the number of bids targeted for placement may be determined based on the number of impressions targeted for purchase during the designated time period as well as the win rate estimated for the designated time period. For instance, a win rate may be estimated as discussed with respect to operation 208 shown in FIG. 2.

In some implementations, in order to purchase imps*(t) during the time period t during which it is estimated that win_rate(t) percent of the bids placed will be successful, the number of bids targeted for placement may be determined by the following equation.

$${bids}^{*} ( t ) = \frac{{imps}^{*} ( t )}{win\_rate ( t )}$$

At 610, a number of requests estimated for receipt during the designated time period is determined. According to various embodiments, different numbers of ad requests may be received during different time periods. The number of requests that are estimated to be received during the designated time period may be determined at least in part based on the pacing rate determined for the time period and the number of bids targeted for placement during the time period. For instance, a pacing rate may be estimated as described with respect to operation 212 shown in FIG. 2.

In some implementations, in order to place bids*(t) bids using a pacing rate of pacing_rate(t), the following equation may be used to determine the number of requests that are estimated to be received during the designated time period.

$${reqs}^{*} ( t ) = \frac{{bids}^{*} ( t )}{pacing\_rate ( t )}$$

FIG. 7 illustrates a request threshold value determination method 700, performed in accordance with one or more embodiments. According to various embodiments, the method 700 may be used to determine a threshold performance metric value for use in determining whether to bid on incoming advertising requests. The threshold may be determined based on information such as a number of requests that are expected to be received during the designated time period

At 702, a request to determine a threshold value for the designated time period is received. According to various embodiments, the request to determine a threshold value may be generated when an estimated number of requests is determined. For instance, an estimated number of requests may be determined as discussed with respect to FIG. 6.

At 704, estimated request information for the designated time period is identified. According to various embodiments, the estimated request information may be determined as discussed with respect to FIG. 6. The estimated request information may indicate a number of requests that are expected to be received during the designated time period.

At 706, a bucketization of historical advertising impression performance metrics is determined for the designated time period. According to various embodiments, determining the bucketization may involve identifying performance metric ranges and counting the number of ad requests that fall within each range. Various techniques exist for bucketization. For instance, buckets may be of fixed size or variable size, with size measured either by the number of ad requests within the bucket or the length of the range of the bucket.

In some implementations, the historical advertising impression performance metrics may be metrics collected for past advertising activity for the advertising campaign. Alternately, or additionally, historical advertising impression performance metrics for other advertising campaigns may be used. For instance, an advertising campaign may be associated with a relatively limited amount of historical information for use in estimating incoming ad request patterns.

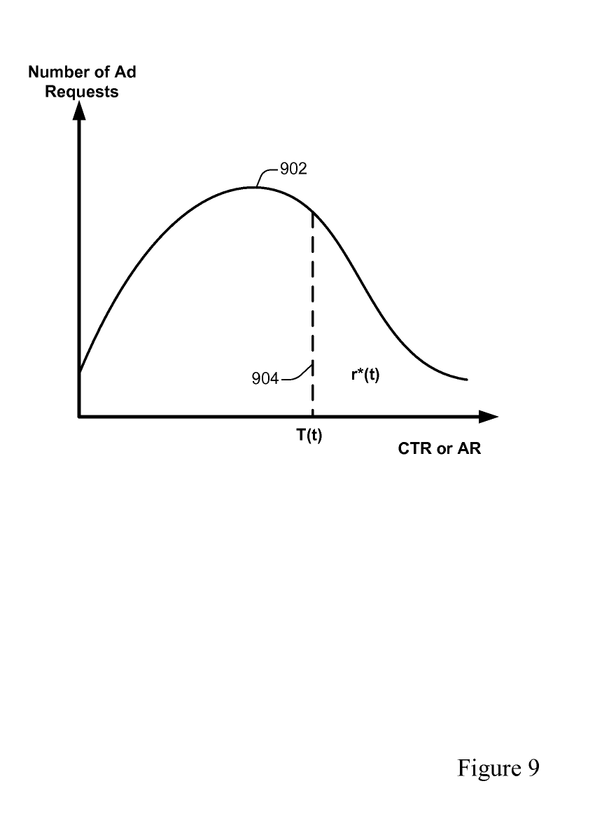

At 708, a histogram of the bucketized performance metrics is created. According to various embodiments, the histogram may be created by estimating a distribution based on the bucketization of the historical advertising impression performance metrics determined as discussed with respect to operation 706. An example of a histogram of the bucketized performance metrics is shown at 902 in FIG. 9.

At 710, a threshold value for the designated time period is determined. According to various embodiments, the threshold value may be determined based on information such as the histogram of the performance metrics determined in operation 708 and the estimated request information determined at operation 704.

An example of a threshold value is shown at 904 in FIG. 9. In FIG. 9, r*(t) represents the volume of ad requests for which bids would be submitted if T(t) were used as a strict threshold value. The threshold may be used to filter ad requests into the region of qₜ(x) with an appropriate CTR or AR such that the smooth delivery constraint is fulfilled. In this way, the budget for the advertising campaign may be spent on purchasing relatively higher quality advertising opportunities.

In some implementations, the threshold value for the designated time period may be determined based on the following equation. In the following equation, qₜ(x) represents the number of ad requests received during the designated time period s that are believed to have a performance metric value (e.g., CTR or AR) of x. Also, reqs*(t) represents a number of requests that are estimated to be received during the designated time period.

$$τ ( t ) = arg {min}_{x} \vert {\int }_{x}^{1} {q}_{t} ( s ) d s - {reqs}^{*} ( t ) \vert$$

FIG. 8 illustrates a threshold window determination method 800, performed in accordance with one or more embodiments. According to various embodiments, the method 800 may be used to determine threshold boundaries such as upper and lower threshold bounds. As discussed with respect to FIG. 5, upper and lower threshold bounds may be used to determine whether to bid on different ad requests having different estimated performance metrics. In some embodiments, using upper and lower threshold bounds rather than a single sharp threshold may help to produce an actual budget expenditure that more closely matches a target budget expenditure.

In some implementations, the performance metric distribution may be computed less frequently than every time period. For this reason and/or for other reasons, a threshold computed as discussed with respect to FIG. 7 may include oscillations. For instance, oscillations may be introduced if the performance metric distribution is not relatively similar to the current ad request distribution. Such a mismatch may occur, for example, if the performance metric distribution is computed using historical data that does not entirely match current advertising request patterns.

At 802, a request to determine a threshold window for a designated time period is received. According to various embodiments, the request to determine the threshold window may be received, for instance, when a new threshold value is generated. The generation of a threshold value is discussed with respect to FIG. 7.

At 804, current and historical request threshold value information is identified. According to various embodiments, current and historical request threshold value information may be stored in a storage system for retrieval upon request. As discussed with respect to operations 806-810, various types of information may be used to determine upper and lower threshold values for the designated time period.

At 806, threshold mean information is determined for the designated time period. According to various embodiments, the threshold mean information may include a value that identifies a central location within a threshold window. For instance, the threshold mean information may identify a mean performance metric value related to the threshold performance metric value determined as discussed with respect to FIG. 7. The threshold mean information for the designated time period may be determined based on information such as threshold mean information for previous time periods, the index of the designated time period, and the threshold value determined for the designated time period.

In some implementations, a threshold mean value may be computed as described by the following equation. The following equation may be used to incrementally update the threshold mean value for successive time periods. In the following equation, μ_{τ}(t) represents the mean value for the designated time period t. Similarly, μ_{τ}(t−1) represents the mean value for the previous time period (t−1). Also, τ(t) represents the threshold value for the designated time period, which may be computed as discussed with respect to FIG. 7. Finally, t represents the index associated with the designated time period. So, t=4 if the designated time period is the fourth time period in a larger time interval such as a day or hour.

$${μ}_{τ} ( t ) = {μ}_{τ} ( t - 1 ) + \frac{1}{t} ( τ ( t ) - {μ}_{τ} ( t - 1 ) )$$

At 808, threshold variance information is determined for the designated time period. According to various embodiments, the threshold variance information may include a value that identifies a distribution spread of ad request performance metric values. For instance, the threshold variance information may identify a performance metric variance value related to the threshold performance metric value determined as discussed with respect to FIG. 7. The threshold variance information for the designated time period may be determined based on information such as threshold mean information for the current and/or previous time periods, the index of the designated time period, the threshold value determined for the designated time period, and the threshold variance information determined for one or more previous time periods.

In some implementations a threshold variance value may be computed as described by the following equation. The following equation may be used to incrementally update the threshold variance value for successive time periods. Many of the symbols used in the following equation are the same as those used in the previous equation. In addition, σ²_{τ}(t) represents the threshold variance value for the designated time period, while σ²_{τ}(t−1) represents the threshold variance value for the previous time period.

$${σ}_{τ}^{2} ( t ) = \frac{t - 1}{t} {σ}_{τ}^{2} ( t - 1 ) + \frac{1}{t} ( τ ( t ) - {μ}_{τ} ( t - 1 ) ) ( τ ( t ) - {μ}_{τ} ( t ) )$$

At 810, upper and lower threshold values for the designated time period are determined. According to various embodiments, the upper and lower threshold values may be determined based on the threshold mean information and the threshold variance information determined as discussed with respect to operations 806 and 808.

In some implementations, one or more assumptions may be used to facilitate the determination of the upper and lower threshold values. For example, the determination may be performed based on an assumption that the threshold value is selected from a Gaussian distribution. As another example, a critical value such as γ=1.96 may be used to provide a 95% confidence interval. However, different types of distributional assumptions and/or different critical values may be used. For instance, distributional assumption and/or critical values may be strategically selected based on information such as historical ad request data and/or desired confidence levels.

According to various embodiments, the upper bound (B_{L}(t)) and the lower bound (B_{U}(t)) may be determined based on the following equations. In these equations, d represents a period of time in the past from which data was used to compute the statistics. For instance, d may represent a number of days, hours, or weeks.

$${B}_{L} ( t ) = {μ}_{τ} ( t ) + γ \frac{{σ}_{τ} ( t )}{\sqrt{d}}$$

$${B}_{U} ( t ) = {μ}_{τ} ( t ) - γ \frac{{σ}_{τ} ( t )}{\sqrt{d}}$$

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
identifying, via a processor, a first threshold value for bid placement, the first threshold value designating a first threshold performance metric level for advertising opportunity bid requests received during a designated time period, the first threshold value being determined at least in part based on one or more historical performance metrics associated with previously received advertising opportunity bid requests;
determining, via the processor, an estimated performance metric for a designated advertising opportunity bid request received during the designated time period; and
transmitting a bid placement message via a communications interface when the estimated performance metric is greater than the first threshold value, the bid request identifying the designated advertising opportunity bid request and a bid placement value.

2. The method recited in claim 1, the method further comprising:
identifying a second threshold value for bid placement, the second threshold value designating a second threshold performance metric level for advertising opportunity bid requests received during the designated time period, the second threshold value being determined at least in part based on the one or more historical performance metrics associated with previously received advertising opportunity bid requests, the second threshold value being less than the first threshold value.

3. The method recited in claim 2,
wherein transmitting the bid placement message via the communications interface when the estimated performance metric is greater than the first threshold value comprises determining a bid placement probability, the bid placement probability identifying a probability of selecting the designated advertising opportunity bid request for bid placement, the bid placement probability being between zero and one.

4. The method recited in claim 3,
wherein the bid placement probability is equal to a target pacing rate, the target pacing rate designating a desired proportion of purchased advertising opportunity bid requests to received advertising opportunity bid requests during the designated time period.

5. The method recited in claim 2,
wherein identifying the first and second threshold values comprises updating one or more threshold values associated with a past time period, the past time period preceding the designated time period.

6. The method recited in claim 5,
wherein identifying the first and second threshold values comprises determining a mean threshold performance metric selected based on the one or more historical performance metrics, the mean threshold performance metric being less than the first threshold value and greater than the second threshold value.

7. The method recited in claim 6,
wherein identifying the first and second threshold values comprises determining a threshold variance value, the threshold variance value indicating a difference between the first and second threshold values.

8. The method recited in claim 1, the method further comprising:
determining a number of requests estimated to be received during the designated time period.

9. The method recited in claim 8,
wherein the number of requests is determined based on one or more of budget pacing information associated with the designated time period, a number of ad impressions targeted for purchase during the designated time period, and a number of bids targeted for placement during the designated time period.

10. The method recited in claim 8,
wherein the first threshold value is determined based on the number of requests estimated to be received during the designated time period and a representation of a distribution of the historical performance metrics.

11. The method recited in claim 1, wherein the estimated performance metric is a metric selected from the group consisting of: an action rate and a click through rate.

12. A system comprising:
memory operable to store a first threshold value for bid placement, the first threshold value designating a first threshold performance metric level for advertising opportunity bid requests received during a designated time period, the first threshold value being determined at least in part based on one or more historical performance metrics associated with previously received advertising opportunity bid requests;
a processor operable to determine an estimated performance metric for a designated advertising opportunity bid request received during the designated time period; and
a communications interface operable to transmit a bid placement message when the estimated performance metric is greater than the first threshold value, the bid request identifying the designated advertising opportunity bid request and a bid placement value.

13. The system recited in claim 12, wherein the processor is further operable to:
identify a second threshold value for bid placement, the second threshold value designating a second threshold performance metric level for advertising opportunity bid requests received during the designated time period, the second threshold value being determined at least in part based on the one or more historical performance metrics associated with previously received advertising opportunity bid requests, the second threshold value being less than the first threshold value.

14. The system recited in claim 13,
wherein transmitting the bid placement message via the communications interface when the estimated performance metric is greater than the first threshold value comprises determining a bid placement probability, the bid placement probability identifying a probability of selecting the designated advertising opportunity bid request for bid placement, the bid placement probability being between zero and one.

15. The system recited in claim 14,
wherein the bid placement probability is equal to a target pacing rate, the target pacing rate designating a desired proportion of purchased advertising opportunity bid requests to received advertising opportunity bid requests during the designated time period.

16. The system recited in claim 13,
wherein identifying the first and second threshold values comprises updating one or more threshold values associated with a past time period, the past time period preceding the designated time period.

17. The system recited in claim 12, wherein the processor is further operable to:
determine a number of requests estimated to be received during the designated time period, wherein the number of requests is determined based on one or more of budget pacing information associated with the designated time period, a number of ad impressions targeted for purchase during the designated time period, and a number of bids targeted for placement during the designated time period.

18. The system recited in claim 17,
wherein the first threshold value is determined based on the number of requests estimated to be received during the designated time period and a representation of a distribution of the historical performance metrics.

19. One or more computer readable media having instructions stored thereon for performing a method, the method comprising:
identifying, via a processor, a first threshold value for bid placement, the first threshold value designating a threshold performance metric level for advertising opportunity bid requests received during a designated time period, the first threshold value being determined at least in part based on one or more historical performance metrics associated with previously received advertising opportunity bid requests;
determining, via the processor, an estimated performance metric for a designated advertising opportunity bid request received during the designated time period; and
transmitting a bid placement message via a communications interface when the estimated performance metric is greater than the first threshold value, the bid request identifying the designated advertising opportunity bid request and a bid placement value.

20. The one or more computer readable media recited in claim 19, the method further comprising:
identifying a second threshold value for bid placement, the second threshold value designating a second threshold performance metric level for advertising opportunity bid requests received during the designated time period, the second threshold value being determined at least in part based on the one or more historical performance metrics associated with previously received advertising opportunity bid requests, the second threshold value being less than the first threshold value.
